(19) United States
(12) Patent Application Publication
(10) Pub. No.: US 2015/0150264 A1
(43) Pub. Date: Jun. 4, 2015

(54) Alkali Metal Bisulfate Method

(71) Applicant: Jones-Hamilton Co., Walbridge, OH (US)

(72) Inventors: Carl J. Knueven, Bowling Green, OH (US); Richard M. Basel, Fostoria, OH (US)

(21) Appl. No.: 14/611,388

(22) Filed: Feb. 2, 2015

Related U.S. Application Data
(62) Division of application No. 13/933,469, filed on Jul. 2, 2013.

(51) Int. Cl. A01N 59/02

(52) U.S. Cl. CPC A01N 59/02

(57) ABSTRACT

An agricultural treatment method involves applying alkali metal bisulfate to modify surface pH on growing plants, or on seeds before planting, in an agricultural area. In certain aspects, the method involves applying an aqueous composition including the alkali metal bisulfate to the plants or seeds. The alkali metal bisulfate may be sodium bisulfate. An aqueous composition includes an alkali metal bisulfate in an amount from 0.1% to 5% by weight. The composition also includes a second material selected from stickers, antimicrobial agents, chelating agents, surfactants, or combinations thereof. Water makes up the final composition.

### BACKGROUND OF THE INVENTION

This invention relates in general to agricultural chemicals, and in particular to chemicals for controlling diseases of agricultural plants.

Agriculture includes the cultivation of plants for food, fiber, biofuel, drugs and other products to sustain and enhance human life. It is a major worldwide industry, second only to the services sector in the number of workers employed. In modern times, improvements in agricultural techniques, machinery, feed stocks and fertilizer have greatly increased the efficiency of agriculture.

However, agricultural plants are still subject to a wide variety of diseases caused by microorganisms. The diseases may decrease plant yield or may even require destruction of the plants. Some of the more common diseases include wilt, blight, blast, rust, mildew, ergo and mosaic. Also, agricultural plants often carry microorganisms that do not cause plant disease but are harmful if ingested by humans or animals.

A large number of different pesticides are known for treating plants to combat diseases, weeds and insects. The pesticides can be categorized depending on their target: bactericides (bacteria), fungicides (fungi), algicides (algae), virucides (viruses), herbicides (weeds) and insecticides (insects). Often the pesticides are applied to the plants in the form of an aqueous spray using agricultural spray equipment.

A common problem with aqueous sprays is that the minerals present in hard water may chelate the pesticide and make it less available to treat the plant. This is especially true of certain fungicides and common herbicides. It is known to add some of the organic acids, particularly citric acid, to an aqueous spray to chelate the minerals and thereby prevent chelation of the pesticide.

Also, some treatment compositions with acids are known in the literature. For example, European Patent Specification EP0565266B1, published Jan. 27, 1999, discloses an aqueous solution of a complex of copper and polycarboxylic acid used to treat bacterial and fungal diseases in plants. It also describes the treatment of plants with a complex of copper and polymethacrylic acid, and with copper amine salts of organic acids.

It would be desirable to provide an improved composition and method for treating agricultural plants.

### SUMMARY OF THE INVENTION

An agricultural treatment method comprises applying alkali metal bisulfate to modify surface pH on growing plants, or on seeds before planting, in an agricultural area. In certain aspects, the method involves applying an aqueous composition including the alkali metal bisulfate to the plants. The alkali metal bisulfate may be sodium bisulfate.

An aqueous composition comprises an alkali metal bisulfate in an amount from about 0.1% to about 5% by weight. The composition also comprises a second material selected from the group consisting of stickers, antimicrobial agents, chelating agents, surfactants, and combinations thereof. Water makes up the final composition.

A pH modifying composition comprises an alkali metal bisulfate in an amount from about 30% to about 80% by weight. The composition also comprises a sticker in an amount from about 20% to about 70% by weight. In certain embodiments, the sticker is a polymeric material or a wax. The composition may further comprise antimicrobial metal particles.

Various aspects of this invention will become apparent to those skilled in the art from the following detailed description of the preferred embodiment.

### DETAILED DESCRIPTION OF THE PREFERRED EMBODIMENT

An agricultural treatment method according to the invention comprises applying alkali metal bisulfate to modify surface pH on growing plants, or on seeds before planting, in an agricultural area. The alkali metal bisulfates include, for example, sodium bisulfate (also known as sodium acid sulfate or sodium hydrogen sulfate), potassium bisulfate (also known as potassium acid sulfate or potassium hydrogen sulfate), or mixtures thereof.

The alkali metal bisulfates have advantages for use in the method compared with organic acids and inorganic acids. Organic acids are relatively weak acidulants and have limited solubility in an aqueous system. Inorganic acids are strong acidulants but do not have the same functional properties as organic acids.

Food grade sodium acid sulfate is manufactured and sold as pHase™ by Jones-Hamilton Co. in Walbridge Ohio. It has been certified as GRAS (Generally Recognized As Safe), and it meets Food Chemicals Codex, 5th Edition Specifications. The sodium acid sulfate is in dry granular crystalline form in particle sizes that can be readily and uniformly dispersed and solubilized in aqueous media. In certain embodiments, the particles having a generally spherical shape with an average diameter from about 0.03 mm to about 1 mm, typically about 0.75 mm. Also, in certain embodiments, the product includes sodium bisulfate in an amount from about 91.5% to about 97.5% by weight (typically about 93%), and sodium sulfate in an amount from about 2.5% to about 8.5% by weight (typically about 7%).

In certain embodiments, the Jones-Hamilton food grade sodium acid sulfate is low in impurities. For example, the product may contain less than about 0.003% heavy metals as Pb, less than about 0.05% water-insoluble substances, and less than about 0.003% selenium by weight. Also, in certain embodiments, the product has a moisture content of less than about 0.8% (measured by loss on drying).

The application of the alkali metal bisulfate to the plants or seeds modifies their surface pH. The modification can include a lowering of the pH or a buffering of the pH. The pH can be lowered to any extent desirable to achieve the desired effect on the plants. In certain embodiments, the surface pH is lowered by at least 2 units, or by at least 3 units, to a pH of 5 or less, or to a pH of 4 or less. By “surface pH” is meant the pH on the outer surface of the plant or seed; for example, the pH on the cuticle of a plant or the seed coat of a seed. The outer surface may be referred to as the “epiphytic” (upon the plant) surface as opposed to “endophytic” (within the plant).

In certain embodiments, applying the alkali metal bisulfate controls microbes on the surface of the plants or seeds, and in particular embodiments it decreases the level of microbes. The term “microbe” is synonymous with “microorganism,” and refers to any noncellular or unicellular (including colonial) organism, including all prokaryotes. Microbes include bacteria (including cyanobacteria), lichens, fungi, protozoa, virinos, viroids, viruses, phages, and some algae. In certain embodiments, the microbes are plant pathogens or human pathogens. In certain embodiments, applying the composition results in a greater than 1 log reduction of microbes, and more particularly a greater than 2 log reduction.

On the epiphytic surface of a plant, the local pH affects what microorganisms can live on the plant and use the nutrients and other components. Many plant and human pathogenic microorganisms are inhibited at a low pH (especially less than 5). The pH modification allows different microorganisms to be selected (i.e. lactic acid bacteria, yeasts, some aciduric bacilli, etc.). This also causes changes in the dynamics of the epiphytic and cuticular surface since many of these more acidophilic microbes also naturally produce inhibitors to many plant and human pathogens. Additionally, many microbes can not only suppress plant pathogens but also displace them.

The pH modification of the plant surface may also affect other materials applied to the plant, such as preservatives, herbicides, fungicides and bactericides. It may affect how well the other materials penetrate the cuticle, the pest that is being targeted, etc. The pH modification may affect fertilizers as some fertilizer components have different solubilities depending upon the pH and hydration of the plant. The application of the alkali metal bisulfate may also include chelation of minerals, for example, to affect mineral uptake and transport into the plant, or to prevent chelation of other materials by the minerals.

The alkali metal bisulfate can be applied on the plants or seeds by any suitable application method. In certain embodiments, as described in more detail below, the alkali metal bisulfate is included in an aqueous composition which is applied to the plants or seeds. The aqueous composition can be applied, for example, by spraying, electrostatic spraying, misting, drenching, soaking, immersing, or any other method of applying an aqueous composition. In certain embodiments, the optimal reduction of pathogens occurs in higher spray levels or drenches. As a result, higher spray volumes may be used for this application: 20−>50 gal/acre for row crops and higher for tree crops. Misting is also recommended as a application method. Especially recommended is electrostatic spraying since the underside and inner canopy of plants get better coverage. The aqueous composition usually dries after it is applied to the plants or seeds and the alkali metal bisulfate concentrates leading to a low pH. Agricultural spray equipment is well known and usually includes a spray tank to hold an aqueous composition and spraying apparatus attached to the tank. Spray tanks vary greatly in size spray tank, but typically a spray tank has a volume within a range of from 2 gallons to 5,000 gallons.

In other embodiments, the alkali metal bisulfate is applied in the form of solid particles. For example, the alkali metal bisulfate may be in the form of relatively fine particles, such as a powder or dust. As mentioned above, the pHase™ sodium acid sulfate is in the form of solid particles typically having an average diameter from about 0.03 mm to about 1 mm. In certain embodiments, the alkali metal bisulfate may be applied as a dust having a particle size wherein less than 2 wt % is retained on a 40 mesh screen and greater than 60 wt % passes through a 100 mesh screen (measured with U.S. Screen sizes). In more particular embodiments it may have a particle size of 400 mesh (0.037 mm) or finer. Different types of dusting equipment that may be used for applying the particles is known in the industry.

The alkali metal bisulfate is applied to growing plants in an agricultural area, and/or applied to seeds before they are planted in an agricultural area. The term “agricultural area”, as used herein, includes any significant area where plants are cultivated, for example, fields, plantations, meadows, lawns, gardens, orchards, greenhouses and forests. In certain embodiments, the agricultural area is at least about 500 square feet in size, and more particularly at least about 1 acre ranging up to hundreds of acres or more. In certain embodiments, an aqueous composition including the alkali metal bisulfate is applied on growing plants plants in an amount of at least 2-5 gallons per acre, and more particularly in an amount of at least 10 gallons per acre, and up to about 100 gallons per acre for a drenching treatment.

Seeds to be planted in an agricultural area are usually sold in bulk or in packages. The quantity may range from a small seed packet to a bulk load.

In certain embodiments, a second material is applied in combination with the alkali metal bisulfate to the plants or seeds. For example, it may be advantageous to apply a sticker in combination with the alkali metal bisulfate to help it adhere to the plant or seed. As another example, when the alkali metal bisulfate has an antimicrobial effect, it may be advantageous to apply a second antimicrobial agent to achieve optimum results. Examples of various materials that may be applied in combination with the alkali metal bisulfate are described in more detail below.

In one embodiment of the invention, an aqueous composition comprises an alkali metal bisulfate in an amount from about 0.1% to about 5% by weight of the composition, or more particularly from about 0.1% to about 1% by weight. For different applications, different amounts of alkali metal bisulfate in the formulation are preferred. For instance in fairly resistant plants, 1% in a spray is preferred while 0.5% is the highest amount preferred with leafy vegetables that more susceptible to phytotoxicity from the acid whereby blotchy callusing results.

The aqueous composition also comprises a second material selected from the group consisting of stickers, antimicrobial agents, surfactants, and combinations thereof. Water makes up the final composition.

The sticker or sticking agent increases adhesion of the alkali metal bisulfate and any other materials to the plants or seeds after application. This helps prevent the materials from being washed off by rain or dew. In some embodiments, the sticker is a polymeric material or a wax. Some particular examples of stickers that may be used include latex (rubber), polyethylene (plastic), resins (such as rosin), pinene polymers, polymenthenes (similar to rosin) and other water proofing agents.

The antimicrobial agent can be any material having an antimicrobial effect. in certain embodiments, the antimicrobial material comprises metal ions. Metal ions, particularly ions of heavy metals, have a toxic effect on microorganisms. Some examples of antimicrobial metals include copper, silver, iron, lead, zinc, bismuth, boron, aluminum, gold, platinum and palladium. The metal ions can be provided by the addition of a metal ion solution or by the addition of metal that leaches ions (for example, in the form of small metal particles). For example, the combination of sodium bisulfate with a copper solution is effective and synergistic. Few human pathogens are resistant to copper. It kills three human pathogens often spread by plant products: Escherichia, Salmonella and Listeria. In certain embodiments, a sticker is added in combination with an alkali metal bisulfate and a metal to prolong their antimicrobial effect.

The antimicrobial agent may also be an antibiotic drug. Antibiotics such as streptomycin and other antimicrobials exhibit their antimicrobial action because of physiological effects on the plant and human pathogen. Other examples include chlorinated antimicrobials, alpha beta unsaturated acids, sulfonic acids, imidazoles, quaternary ammonium compounds, amines, phenoxyalkylamines, haophenoxy amities and N-benzyl-N-phenoxyethylamines. Changing the pH so that microbes grow in lower numbers epiphytically can result in less hardy pathogens that are more susceptible to antimicrobial actions. The mechanism of absorption of an antibiotic may affect what the optimal pH of the final composition should be.

The antimicrobial agent may also be a natural product that functions as an antimicrobial. Examples include natural compounds such as menthol or menthol glycosides, other natural products such as alginates, and plant extracts such as Yucca extracts. These extracts have special activity against Xanthomonas and other plant pathogens. They can be potentiated by lowering the pH which not only augments absorption, but also causes leakage and other microbial distress. Other extracts of interest include protein extracts of Trichoderma sp. The antimicrobial agent may be a biological inhibitor (e.g., extracts spores or vegetative cells). SAR (systematic acquired resistance) inhibitors can also be used. Chitosan and other organic products also have antimicrobial properties for controlling plant pathogens.

The surfactant can be any type suitable for application to plants or seeds. Some examples include organosilicon surfactants. Many other EPA registered agricultural surfactants are known in the industry. The surfactant can augment the action of the alkali metal bisulfate and a second antimicrobial material if included.

In addition, the aqueous compositions can also include other materials useful for application to plants or seeds, such as chelating agents, preservatives, various adjuvants, and other materials typically applied in a tank mix for other purposes.

Some diseases that are most important on plants include bacterial diseases. These include Xanthomonas species, Clavibacter, Erwinia and many other bacteria. The epiphytic counts of these pathogens can be kept down by the application of the alkali metal bisulfate composition. Just like with the human pathogens, both copper and other antimicrobials along with a sticker are preferred applications. Bacterial diseases cause great harm to agricultural crops, especially cotton, tobacco, tomatoes, potatoes, cabbage, and cucumbers. These diseases vary from being systemic (causing plant death) or can affect individual parts of the plant (leaves fruits or roots). These effects can also occur in the vascular tissue or parenchymatous tissues (rot spots and blights) or they can cause tumors (like Agrobacter species). Many bacteria responsible for these diseases include the Pseudomonadaceae and Bacteriacae. These organisms may attack only one host species or many. Polyphagous bacteria can cause widespread bacterioses including soft rot of potatoes, cabbage, onions and tomatoes.

A number of field crops are affected by bacterial diseases. Many of the large acreage field crops (i.e. corn, wheat, soybeans, rice, etc.) have resistance to bacterial diseases. However, some of the smaller acreage crops have less resistance. Corn, one of the more resistant crops, still can get Stewart's bacterial wilt and leaf blot. This organism overwinters in the gut of the flea beetle and is carried directly into the plant. Stalk rot is also caused by Erwinia. There are a number of diseases also caused by bacteria in soybeans. These include bacterial blight, pustule, halo blight (caused by Pseudomonas syringae pv. phaseolicola), bacterial brown spot (caused by Pseudomonas syringae pv. syringae) and common bacterial blight (caused by Xanthomonas campestris pv. phaseoli or Xanthomonas axonopodis pv. phaseoli). Soybean pustule xanthomonas axonopodis var. malvacearium is also found on beans. Bacterial wilt (caused by Curtobacterium flaccumfaciens ssp. flaccumfaciens) has also been reported. A very severe disease of rice is blight caused by Xanthomonas oryzicola or oryzae. This disease is particularly spread by seeds. Wheat is also particularly prone to a bacterial disease called yellow ear rot caused by Clavibacter trifici. Often wheat has to be treated for worms close to harvest. This means that we can include alkali metal bisulfate in a pesticide spray with an added sticker to help control it. Finally, bacterial blight of barley is caused by Xanthomonas campestris pv. translucens.

Bacterial diseases also affect many widely raised specialty crops including cotton, tobacco, and sugarcane. The Bacterial blight or angulax leaf spot or black arm of cotton is a disease caused by Xanthomonas campestris. The disease not only spreads through the penetration into the plant through the vascular tissue, it also spreads along the veins. This bacteria not only affects the plant, it also affects the boll and can be spread through the cotton and dead tissue, since it can survive for up to 17 years. Clavibacter zylii causes degeneration and deterioration of sugar cane. Tobacco is susceptible to many bacteria, but the main bacterial diseases affecting tobacco include angular leaf spot (Pseudomonas amygdaiipv pv. tabaci), Granville wilt (Ralstonia solanacearum), hairy roots (Agrobacterium rhizogenes), hollow stalk (Erwinia carotovora subsp. Carotovora), wild fire (Pseudomonas syringae), and leaf gall (Rhodococcus fascians).

There are also a number of tree diseases that are caused by bacteria. Among the most important is citrus canker which is caused by Xanthomonas cirri. It is quite serious in many parts of the world. Citrus canker occurs on leaves, twigs, thorns, older branches and fruits. Leaf lesions first appear as small, round, watery, and translucent spots. These are raised and become yellowish brown. They first develop on the lower surface of the leaf and then both the surfaces of the leaf are affected. These lesions are caused by bacteria. While the syndrome affects the leaves, it does not affect the interior of the fruit. Citrus greening disease caused by another microorganism. This disease is more related to entry by insects that can only be influenced by the use of pesticides. Leaf spot of mango is caused by Xanthomonas compestris pv. maniferae indici. This disease produces water soaked lesions that become black and may be surrounded by chlorotoic halos. Additionally, bacterial spot is caused by Zanthomonas pruni which affects leaves and the fruit for crops such as apples unmarketable because the cracking and holes in the fruit. Bacterial leaf spot can also affect peach fruit. Vine crops such as grapes are also prone to bacterial diseases. These include bacterial necrosis (Xylophilus ampelinus or Xanthomonas ampelina), crown gall, and Pierce's disease caused by Xylella fastidiosa.

There are many bacterial pathogens that cause diseases of vegetable crops. They include the gram negative genera Acidovorax, Agrobacteriwn, Erwinia, Pseudomonas, Ralsonia, Serratia, Rhizomonas, and Xanthomonas. There are also gram positive bacteria that cause disease including Clavibacter (Corneyobacter). Some of these are seed borne and include Pseudomonas syringae and Xanthomonas campestris in brassicas, carrot, celery, lettuce, peas, peppers, and tomato.

While it is not possible to discuss all the diseases of plants, it is clear that the composition and method of the invention can be helpful in preventing them and in lowering the infection rate and severity.

In another embodiment of the invention, a pH modifying composition comprises an alkali metal bisulfate in an amount from about 30% to about 80% by weight of the composition; and a sticker in an amount from about 20% to about 70% by weight of the composition. In certain embodiments, the composition further includes an antimicrobial metal.

The pH modifying composition could be applied to plants and seeds, or it could be used for different applications. Some examples of other applications include adjusting soil pH, or treating areas of insect or pest harborage or plant debris.

### EXAMPLES

### Example 1

### Greenhouse

Field Tomatoes (Variety H3402) were grown in 3 gallon pots in the greenhouse. When the plants were grown so that they had tomatoes of at least 1 inch, they were sprayed with a culture of Xanthomonas gardneri, a pathogen of tomato causing bacterial spot in Midwest Ohio. One day after the plants were inoculated by spraying with a dilute culture at a rate of 50 gal/acre, some plants were sprayed with various chemicals that are used for lowering microbial numbers on plants. Included in these sprays were sprays of pHase™ (sodium bisulfate). Twenty four hours after these sprays were made, the plant tissue was aseptically harvested and dilution plating was used to estimate the number of Xanthomonas gardneri.

ONE DAY FROM SPRAY

| | % | | Other | Ratio Xanth/ |
|---|---|---|---|---|
| | disease | Xanth | Microbes | Total Plate Count |
| Control | 20 | 196000 | 124000 | 61% |
| Copper | <5 | 148000 | 181000 | 45% |
| Copper/EDBC | <5 | 239000 | 41000 | 85% |
| EDBC | <5 | 210000 | 33000 | 86% |
| Oxidate | <5 | 106000 | 23000 | 82% |
| Root Tone | <5 | 153000 | 172000 | 47% |
| Serenade | <5 | 58000 | 428000 | 12% |
| Culture 1 | <5 | 6000 | 20000 | 23% |
| Culture 2 | <5 | 87000 | 386000 | 18% |

ONE WEEK FROM SPRAY

| | | | | Ratio Xanth/ | |
|---|---|---|---|---|---|
| | Total % | | Other | Total Plate | |
| | disease | Xanth | Microbes | Count | Total |
| Control | 60 | 2800000 | 100000 | 97% | 2900000 |
| Copper | <5 | 2000000 | 300000 | 87% | 2300000 |
| Copper/ | <5 | 980000 | 210000 | 82% | 1190000 |
| EDBC | | | | | |
| EDBC | <5 | 400000 | 29000 | 93% | 429000 |
| Oxidate | 7 | 4900000 | 0 | 100% | 4900000 |
| Root Tone | 7 | 3600000 | 400000 | 90% | 4000000 |
| Serenade | 7 | 0 | 7100000 | 0% | 7100000 |
| Culture 1 | 12 | 7900000 | 7800000 | 50% | 15700000 |
| Culture 2 | 12 | 600000 | 38900000 | 2% | 39500000 |
| 0.1% pHase | <5 | 300000 | 900000 | 25% | 1200000 |
| 5/14 | | | | | |
| Agrimycin | <5 | 7800000 | 410000 | 95% | 8210000 |
| 5/20 | | | | | |

We see from the above tables that after 1 day and 1 week from spray in the greenhouse, tomato plants have a reduced level of the pathogen Xanthomonas gardneri. After 1 week, the spray should probably be repeated as the pHase™ without a sticker will wash off. This treatment worked better than all the treatments except where cultures were applied to the pathogens. However, only Serenade had lower levels of Xanthomonas gardneri than pHase™ at 0.1.%. Outside, Sodium Bisulfate could be used at 0.5-1% depending upon the crop. This treatment also lowered the levels of pathogens such as Xanthomonas campestris and Clavibacter. Therefore, in the greenhouse levels of between 0.1 and 0.5% of sodium bisulfate as a spray are recommended. The exact level should be determined based upon a test as some plants are more susceptible to injury than others. No phytotoxicity has been found at the 0.1% level used in this test.

### Example 2

### Outside Tomatoes

Outside field tomatoes variety H3402 were inoculated with Xanthomonas gardneri and then sprayed weekly with various treatments. The leaf defoliation and spot formation are commonly used as indicators of disease. The following data show that these indicators of disease severity showed positive effects from sodium acid sulfate. Better results were found when a sticker was included with sodium acid sulfate, but are not shown because they were not replicated fully. In these studies the numbers of spotted tomatoes decreased as well.

| | Average | |
|---|---|---|
| | Defoliation | |
| | score | |
| Control | 85 | D |
| Cu* Actiguard | 32 | AB |
| Cu Actiguard Manozeb | 24 | A |
| Cu Serenade | 24 | A |
| Oxidate | 60 | C |
| 1% pHase ™ | 40 | BC |
| 0.5% pHase ™ | 45 | BC |
| 0.5% pHase ™ and Cu* | 22 | A |
| 0.5% pHase ™ and Bond | 28 | A |
| sticker | | |

*Cu used is the label amount of Kocide.

### Example 3

### Lettuce

In this trial, three lettuce varieties (Fire Ice leaf lettuce blend, Green Towers Romaine Lettuce, and Ithaca head lettuce) were raised in 72 cell trays until they were 4-6 inches tall. At this time, each tray was sprayed with the control trial pathogen surrogate. The control Salmonella surrogate was NRRL B-2354. The Escherichia coil was non-pathogenic strain K12. These were grown in nutrient broth supplemented with 5 gm/l glucose. The broth was centrifuged at 5000 g and re-suspended in physiological saline. This material was sprayed using a standard sprayer at 50 gal/acre. The resultant control pathogen levels are shown as found two days later on control trays. For the test trays, a 0.5% or 1% spray of pHase™ was made at the rate of 50 gal/acre. The average of testing is shown below.

| | | | Count 1 day after Spray | |
|---|---|---|---|---|
| Treatment | Variety | Control | 0.5% pHase | 1% pHase* |
| Salmonella sp. | Fire Ice | 230000000/gm | 11200/gm | 7400/gm |
| | Green | | 6800/gm | 6500/gm |
| | Towers | | | |
| | Ithaca | | 31000/gm | 8000/gm |
| Escherichia coli | Fire Ice | 53000000/gm | 5600/gm | 3100/gm |
| | Green | | 3660/gm | 2880/gm |
| | Towers | | | |
| | Ithaca | | 7300/gm | 5800/gm |

*Concentration producing spotting

Note that there is about a 4 log reduction of the pathogens when pHase™ is sprayed on crops in the field. These tests show that pHase™ can be used to treat plants to reduce the amount of human pathogens as well as plant pathogens.

### Example 4

### Seed

We wanted to test whether washing alfalfa sprout seeds and mungbean seeds would reduce the levels of pathogens. To do this, pHase™ was milled to 400 mesh and 0.05% of pHase™ particulates per gm of seeds were shaken with the seeds in a bag. When Escherichia coli or Salmonella /gm were applied to seeds and dried, approximately 100000 cfu/gm of the surrogates were found in the control seeds after 3 days, but less than 10 cfu/gm were found in all cases after 5 days. It is anticipated that this treatment could also help with plant pathogens that are carried on the seed. Typically, most of the contamination comes when plant pathogens on the harvested fruit get on the seeds.

### Example 5

### Aqueous Spray Composition

An aqueous spray composition is prepared including 1 wt % sodium bisulfate, 0.5 wt % surfactant and 98.5% water. A sticker may be added in an amount of 0.5 wt %.

The principle and mode of operation of this invention have been explained and illustrated in its preferred embodiment. However, it must be understood that this invention may be practiced otherwise than as specifically explained and illustrated without departing from its spirit or scope.

1. An agricultural treatment method comprising applying bisulfate ion to modify surface pH on growing plants, or on seeds before planting, in an agricultural area.

2. The method of claim 1 which comprises applying an aqueous composition including the bisulfate ion.

3. The method of claim 1 which comprises applying powdered alkali metal bisulfate.

4. The method of claim 2 wherein the aqueous composition is applied on growing plants in an amount of at least 20 gallons per acre (30.6 liters per hectare).

5. The method of claim 4 wherein the aqueous composition is applied by spraying or misting.

6. The method of claim 1 which comprises lowering the surface pH by at least 2 units to a pH of 5 or less.

7. The method of claim 1 wherein applying the bisulfate ion decreases a level of microbes on the surface.

8. The method of claim 7 wherein the microbes include plant or human pathogens.

9. The method of claim 1 further comprising applying a sticker in combination with the bisulfate ion.

10. The method of claim 7 further comprising applying a second antimicrobial agent in combination with the bisulfate ion.
